(19) United States
(12) Patent Application Publication
(10) Pub. No.: US 2026/0220642 A1
(43) Pub. Date: Jul. 30, 2026

(54) Method, System, and Computer Program Product for Encapsulated Multi-Functional Framework

(71) Applicant: Visa International Service Association, San Francisco, CA (US)

(72) Inventors: Xiao Tian, Austin, TX (US); Can Liu, Lucas, TX (US); Chiranjeet Chetia, Round Rock, TX (US)

(21) Appl. No.: 19/145,634

(22) PCT Filed: Jan. 3, 2024
(86) PCT No.: PCT/US2024/010135

§ 371 Date: Jul. 3, 2025

Related U.S. Application Data
(60) Provisional application No. 63/478,375, filed on Jan. 4, 2023.

(51) Int. Cl. G06Q 20/40; G06N 20/00

(52) U.S. Cl. CPC G06Q 20/4016; G06N 20/00

(57) ABSTRACT

Methods, systems, and computer program products for encapsulated multi-functional framework: obtain a plurality of features associated with an instance, the plurality of features including a first subset of the plurality of features associated with a first entity, a second subset of the plurality of features associated with a second entity, and a third subset of the plurality of features associated with each of the first entity and the second entity; train, based on the plurality of features, a plurality of machine learning models encapsulated in a single framework; generate, based on a plurality of first weighted outputs, a plurality of second weighted outputs, and a plurality of third weighted outputs, a prediction for the instance; and provide the prediction for the instance.

### CROSS-REFERENCE TO RELATED APPLICATIONS

This application is the United States national phase of International Application No. PCT/US24/10135, filed Jan. 3, 2024, and claims the benefit of U.S. Provisional Application No. 63/478,375, filed Jan. 4, 2023, the disclosures of which are hereby incorporated by reference in their entireties.

### BACKGROUND

### 1. Technical Field

This disclosure relates to machine learning or artificial intelligence (AI)-powered solutions and, in some non-limiting embodiments or aspects, to methods, systems, and computer program products for encapsulated multi-functional framework.

### 2. Technical Considerations

Challenges associated with providing machine learning or Artificial Intelligence (AI)-powered solutions may include complex and diverse client data patterns, diverse client profiles, and/or uninterpretable models. Complex and diverse client data patterns may result in computationally expensive data processing and aggregation caused by data skew and/or compromised performance due to mixed data patterns. For example, a single model cannot handle complex data patterns and data skewness. Diverse client profiles may result in a different model for each client, which may cause the underutilization of information (e.g., clients may not use information from other clients, etc.) and/or expenses and errors prone to occur from the development, deployment, and maintenance of multiple different models, and/or a single model for all clients, which may cause all information to be treated equally, thereby reducing model customization and precision for different clients. For example, uniform predictions at an output cannot properly meet diverse client requests. Uninterpretable black box models may cause low confidence in model predictions.

### SUMMARY

Accordingly, provided are improved methods, systems, and computer program products for machine learning or Artificial Intelligence (AI)-powered solutions.

According to some non-limiting embodiments or aspects, provided is a method, including: obtaining, with at least one processor, a plurality of features associated with an instance, wherein the plurality of features includes a first subset of the plurality of features associated with a first entity, a second subset of the plurality of features associated with a second entity, and a third subset of the plurality of features associated with each of the first entity and the second entity; training, with the at least one processor, a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generating, with the at least one processor, based on the plurality of first weighted outputs, the plurality of second weighted outputs, and the plurality of third weighted outputs, a prediction for the instance; and providing, with the at least one processor, the prediction for the instance.

In some non-limiting embodiments or aspects, the obtaining, with the at least one processor, the plurality of features associated with the instance includes: segmenting each feature of the plurality of features into one of the first subset, the second subset, and the third subset.

In some non-limiting embodiments or aspects, the generating, with the at least one processor, based on the plurality of first weighted outputs, the plurality of second weighted outputs, and the plurality of third weighted outputs, the prediction for the instance includes: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction.

In some non-limiting embodiments or aspects, the prediction for the instance is provided with the plurality of first learnable weights, the plurality of second learnable weights, and the plurality of third learnable weights.

In some non-limiting embodiments or aspects, the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the method further includes: automatically authorizing or automatically denying, with the at least one processor, based on the prediction, the transaction.

In some non-limiting embodiments or aspects, the instance includes a credit application initiated by a customer with a merchant, wherein the first entity includes the customer, wherein the second entity includes the merchant, wherein the prediction includes an amount for which the credit application is approved, and wherein the method further includes: automatically approving, with the at least one processor, based on the prediction, the credit application for the amount.

In some non-limiting embodiments or aspects, the instance includes a house price estimation for a house in a neighborhood, wherein the first entity includes the house, wherein the second entity includes the neighborhood, wherein the prediction includes an estimated price of the house, and wherein the method further includes: automatically controlling, with the at least one processor, based on the prediction, a display to display the estimated price of the house in a map of the neighborhood at a location of the house in the map.

According to some non-limiting embodiments or aspects, provided is a system, including: at least one processor programmed and/or configured to: obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity; train a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generate, based on the plurality of first weighted outputs, the plurality of second weighted outputs, and the plurality of third weighted outputs, a prediction for the instance; and provide the prediction for the instance.

In some non-limiting embodiments or aspects, the at least one processor is programmed and/or configured to obtain the plurality of features associated with the instance by: segmenting each feature of the plurality of features into one of the first subset, the second subset, and the third subset.

In some non-limiting embodiments or aspects, the at least one processor is programmed and/or configured to generate, based on the plurality of first weighted outputs, the plurality of second weighted outputs, and the plurality of third weighted outputs, the prediction for the instance by: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction.

In some non-limiting embodiments or aspects, the prediction for the instance is provided with the plurality of first learnable weights, the plurality of second learnable weights, and the plurality of third learnable weights.

In some non-limiting embodiments or aspects, the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the at least one processor is further programmed and/or configured to: automatically authorize or automatically deny, based on the prediction, the transaction.

In some non-limiting embodiments or aspects, the instance includes a credit application initiated by a customer with a merchant, wherein the first entity includes the customer, wherein the second entity includes the merchant, wherein the prediction includes an amount for which the credit application is approved, and wherein the at least one processor is further programmed and/or configured to: automatically approve, based on the prediction, the credit application for the amount.

In some non-limiting embodiments or aspects, the instance includes a house price estimation for a house in a neighborhood, wherein the first entity includes the house, wherein the second entity includes the neighborhood, wherein the prediction includes an estimated price of the house, and wherein the at least one processor is further programmed and/or configured to: automatically control, based on the prediction, a display to display the estimated price of the house in a map of the neighborhood at a location of the house in the map.

According to some non-limiting embodiments or aspects, provided is a computer program product including at least one non-transitory computer-readable medium including program instructions that, when executed by at least one processor, cause the at least one processor to: obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity; train a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generate, based on the plurality of first weighted outputs, the plurality of second weighted outputs, and the plurality of third weighted outputs, a prediction for the instance; and provide the prediction for the instance.

In some non-limiting embodiments or aspects, the program instructions, when executed by the at least one processor, cause the at least one processor to obtain the plurality of features associated with the instance by: segmenting each feature of the plurality of features into one of the first subset, the second subset, and the third subset.

In some non-limiting embodiments or aspects, the program instructions, when executed by the at least one processor, cause the at least one processor to generate, based on the plurality of first weighted outputs, the plurality of second weighted outputs, and the plurality of third weighted outputs, the prediction for the instance by: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction, wherein the prediction for the instance is provided with the plurality of first learnable weights, the plurality of second learnable weights, and the plurality of third learnable weights.

In some non-limiting embodiments or aspects, the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the program instructions, when executed by the at least one processor, further cause the at least one processor to: automatically authorize or automatically deny, based on the prediction, the transaction.

In some non-limiting embodiments or aspects, the instance includes a credit application initiated by a customer with a merchant, wherein the first entity includes the customer, wherein the second entity includes the merchant, wherein the prediction includes an amount for which the credit application is approved, and wherein the program instructions, when executed by the at least one processor, further cause the at least one processor to: automatically approve, based on the prediction, the credit application for the amount.

In some non-limiting embodiments or aspects, the instance includes a house price estimation for a house in a neighborhood, wherein the first entity includes the house, wherein the second entity includes the neighborhood, wherein the prediction includes an estimated price of the house, and wherein the program instructions, when executed by the at least one processor, further cause the at least one processor to: automatically control, based on the prediction, a display to display the estimated price of the house in a map of the neighborhood at a location of the house in the map.

Further non-limiting embodiments or aspects are set forth in the following numbered clauses:

Clause 1: A method, comprising: obtaining, with at least one processor, a plurality of features associated with an instance, wherein the plurality of features includes a first subset of the plurality of features associated with a first entity, a second subset of the plurality of features associated with a second entity, and a third subset of the plurality of features associated with each of the first entity and the second entity; training, with the at least one processor, a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generating, with the at least one processor, based on the plurality of first weighted outputs, the plurality of second weighted outputs, and the plurality of third weighted outputs, a prediction for the instance; and providing, with the at least one processor, the prediction for the instance.

Clause 2: The method of clause 1, wherein the obtaining, with the at least one processor, the plurality of features associated with the instance includes: segmenting each feature of the plurality of features into one of the first subset, the second subset, and the third subset.

Clause 3: The method of clauses 1 or 2, wherein the generating, with the at least one processor, based on the plurality of first weighted outputs, the plurality of second weighted outputs, and the plurality of third weighted outputs, the prediction for the instance includes: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction.

Clause 4: The method of any of clauses 1-3, wherein the prediction for the instance is provided with the plurality of first learnable weights, the plurality of second learnable weights, and the plurality of third learnable weights.

Clause 5: The method of any of clauses 1-4, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the method further includes: automatically authorizing or automatically denying, with the at least one processor, based on the prediction, the transaction.

Clause 6: The method of any of clauses 1-5, wherein the instance includes a credit application initiated by a customer with a merchant, wherein the first entity includes the customer, wherein the second entity includes the merchant, wherein the prediction includes an amount for which the credit application is approved, and wherein the method further includes: automatically approving, with the at least one processor, based on the prediction, the credit application for the amount.

Clause 7: The method of any of clauses 1-6, wherein the instance includes a house price estimation for a house in a neighborhood, wherein the first entity includes the house, wherein the second entity includes the neighborhood, wherein the prediction includes an estimated price of the house, and wherein the method further includes: automatically controlling, with the at least one processor, based on the prediction, a display to display the estimated price of the house in a map of the neighborhood at a location of the house in the map.

Clause 8: A system, comprising: at least one processor programmed and/or configured to: obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity; train a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generate, based on the plurality of first weighted outputs, the plurality of second weighted outputs, and the plurality of third weighted outputs, a prediction for the instance; and provide the prediction for the instance.

Clause 9: The system of clause 8, wherein the at least one processor is programmed and/or configured to obtain the plurality of features associated with the instance by: segmenting each feature of the plurality of features into one of the first subset, the second subset, and the third subset.

Clause 10: The system of clauses 8 or 9, wherein the at least one processor is programmed and/or configured to generate, based on the plurality of first weighted outputs, the plurality of second weighted outputs, and the plurality of third weighted outputs, the prediction for the instance by: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction.

Clause 11: The system of any of clauses 8-10, wherein the prediction for the instance is provided with the plurality of first learnable weights, the plurality of second learnable weights, and the plurality of third learnable weights.

Clause 12: The system of any of clauses 8-11, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the at least one processor is further programmed and/or configured to: automatically authorize or automatically deny, based on the prediction, the transaction.

Clause 13: The system of any of clauses 8-12, wherein the instance includes a credit application initiated by a customer with a merchant, wherein the first entity includes the customer, wherein the second entity includes the merchant, wherein the prediction includes an amount for which the credit application is approved, and wherein the at least one processor is further programmed and/or configured to: automatically approve, based on the prediction, the credit application for the amount.

Clause 14: The system of any of clauses 8-13, wherein the instance includes a house price estimation for a house in a neighborhood, wherein the first entity includes the house, wherein the second entity includes the neighborhood, wherein the prediction includes an estimated price of the house, and wherein the at least one processor is further programmed and/or configured to: automatically control, based on the prediction, a display to display the estimated price of the house in a map of the neighborhood at a location of the house in the map.

Clause 15: A computer program product comprising at least one non-transitory computer-readable medium including program instructions that, when executed by at least one processor, cause the at least one processor to: obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity; train a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generate, based on the plurality of first weighted outputs, the plurality of second weighted outputs, and the plurality of third weighted outputs, a prediction for the instance; and provide the prediction for the instance.

Clause 16: The computer program product of clause 15, wherein the program instructions, when executed by the at least one processor, cause the at least one processor to obtain the plurality of features associated with the instance by: segmenting each feature of the plurality of features into one of the first subset, the second subset, and the third subset.

Clause 17: The computer program product of clauses 15 or 16, wherein the program instructions, when executed by the at least one processor, cause the at least one processor to generate, based on the plurality of first weighted outputs, the plurality of second weighted outputs, and the plurality of third weighted outputs, the prediction for the instance by: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction, wherein the prediction for the instance is provided with the plurality of first learnable weights, the plurality of second learnable weights, and the plurality of third learnable weights.

Clause 18: The computer program product of any of clauses 15-17, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the program instructions, when executed by the at least one processor, further cause the at least one processor to: automatically authorize or automatically deny, based on the prediction, the transaction.

Clause 19: The computer program product of any of clauses 15-18, wherein the instance includes a credit application initiated by a customer with a merchant, wherein the first entity includes the customer, wherein the second entity includes the merchant, wherein the prediction includes an amount for which the credit application is approved, and wherein the program instructions, when executed by the at least one processor, further cause the at least one processor to: automatically approve, based on the prediction, the credit application for the amount.

Clause 20: The computer program product of any of clauses 15-19, wherein the instance includes a house price estimation for a house in a neighborhood, wherein the first entity includes the house, wherein the second entity includes the neighborhood, wherein the prediction includes an estimated price of the house, and wherein the program instructions, when executed by the at least one processor, further cause the at least one processor to: automatically control, based on the prediction, a display to display the estimated price of the house in a map of the neighborhood at a location of the house in the map.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for encapsulated multi-functional framework;

FIG. 4 is a diagram of an implementation of non-limiting embodiments or aspects of an encapsulated multi-functional framework;

FIG. 5 is a diagram of an implementation of non-limiting embodiments or aspects of learnable aggregation weights of an encapsulated multi-functional framework;

FIG. 6A illustrates bank accounts and transactions associated with a real time payment (RTP) network; and

FIG. 6B illustrates different financial institution profiles associated with an RTP network.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device”, as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway” may refer to one or more computer systems, computer devices, servers, groups of servers, and/or the like operated by or on behalf of a payment gateway.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the terms “request,” “response,” “request message,” and “response message” may refer to one or more messages, data packets, signals, and/or data structures used to communicate data between two or more components or units.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

As used herein, the terms “peer-to-peer payment transfer service” and “peer-to-peer payment transfer application” refer to one or more electronic devices and/or software applications configured to initiate and/or conduct person-to-person (e.g., account-to-account, etc.) transfers of payments or funds. For example, a peer-to-peer payment transfer service may include mobile devices executing a peer-to-peer payment transfer application, and may further include server-side software and/or databases (e.g., a payee database, a payer database, etc.) for maintaining and providing request data and transaction data to the mobile devices. A “peer-to-peer payment transfer service provider” may include an entity that provides and/or maintains a peer-to-peer payment transfer service for customers, such as Visa Direct®, and/or other like peer-to-peer payment transfer services. In some non-limiting examples, a transaction service provider may be a peer-to-peer payment transfer service provider.

As used herein, the term “real-time payment (RTP)” refers to a method of electronic funds transfer, allowing for almost or near immediate transfer of money between accounts, which is in contrast to the previous transfer times of one to three business days. For example, RTP means a payment transaction is not subjected to any waiting period, with funds being transferred and/or transactions being settled as soon as the payment transactions are processed by the RTP system.

“Real-time” refers to the capability of a system or process to receive, process, and respond to inputs or events within a timeframe that is imperceptible to the user or in accordance with the constraints of the application domain. In the context of machine learning, real-time denotes the ability to perform data processing, analysis, and decision-making instantly or within milliseconds, ensuring that the output or action is delivered virtually immediately after the input is received, thus enabling timely and responsive operation.

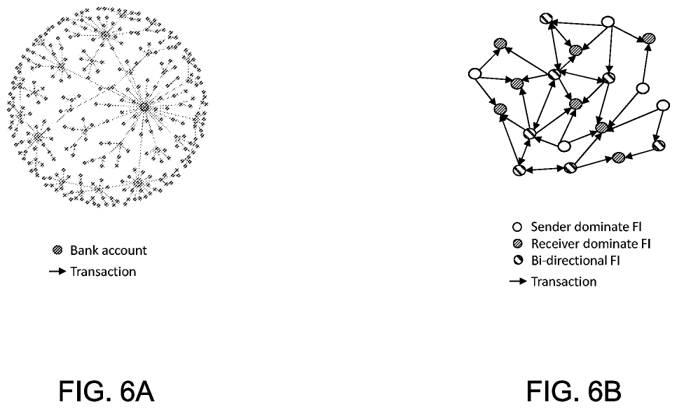

As previously described herein, complex and diverse client data patterns may result in computationally expensive data processing and aggregation caused by data skew and/or compromised performance due to mixed data patterns. For example, transaction data associated with a financial institution participating in a real-time payment (RTP) network may suffer from data skew and/or mixed patterns. As an example, and referring to FIG. 6A, which illustrates bank accounts and transactions associated with an RTP network, although most sender and receiver accounts associated with an RTP network may be associated with a small amount of transactions (e.g., ~2 transactions, etc.), transaction data may be skewed by a sender account that sends out many more transactions (e.g., tens of millions of transactions, etc.) and/or a receiver account that receives many more transactions (e.g., millions of transactions, etc.). Further, and referring to FIG. 6B, which illustrates different financial institution profiles associated with an RTP network, the financial institutions associated with the RTP network may have diverse profiles, for example, a sender dominate financial institution, a receiver dominate financial institution, and a bi-directional or balanced financial institution. Moreover, a financial institution associated with an RTP network may have low confidence in model predictions from an uninterpretable black box model (e.g., a fraud prediction model, etc.).

Non-limiting embodiments or aspects of the disclosed subject matter are directed to methods, systems, and computer program products that provide a single deployment that can meet diverse client needs, thereby reducing cost for deployment and maintenance; a model agnostic framework that can be used for many different types of models (e.g., supervised models, unsupervised models, sequential models, non-sequential models, etc.); higher performance for complex user profiles that take advantage of global information and highlight on uniqueness of users; more customization and flexibility to provide richer output in real-time to meet diverse client requirements; and/or explainable predictions that increase user confidence.

To achieve these benefits, non-limiting embodiments or aspects of the disclosed subject matter may obtain a plurality of features associated with an instance, the plurality of features including a first subset of the plurality of features associated with a first entity, a second subset of the plurality of features associated with a second entity, and a third subset of the plurality of features associated with each of the first entity and the second entity; train a plurality of machine learning models encapsulated in a single framework, by: providing, as input to a first machine learning model, the first subset of the plurality of features and, receiving as output from the first machine learning model, a plurality of first outputs; providing, as input to a second machine learning model, the second subset of the plurality of features and, receiving as output from the second machine learning model, a plurality of second outputs; providing, as input to a third machine learning model, the third subset of the plurality of features and, receiving as output from the third machine learning model, a plurality of third outputs; learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs; learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs; generating, with the at least one processor, based on the plurality of first weighted outputs, the plurality of second weighted outputs, and the plurality of third weighted outputs, a prediction for the instance; and providing, with the at least one processor, the prediction for the instance.

In this way, non-limiting embodiments or aspects of the disclosed subject matter may separate and rearrange input based on diverse patterns, data skewness, and diverse client requests to different computational channels while training the plurality of machine learning models, the plurality of first learnable weights, the plurality of second learnable weights, and/or the plurality of third learnable weights together as a single encapsulated framework or model.

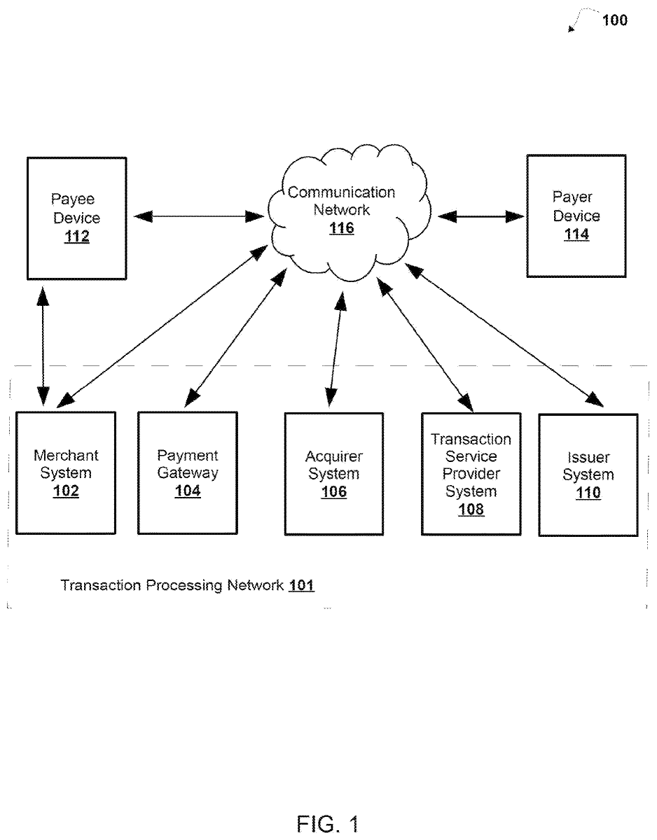

Referring now to FIG. 1, FIG. 1 is a diagram of an example environment 100 in which devices, systems, methods, and/or products described herein, may be implemented. As shown in FIG. 1, environment 100 includes transaction processing network 101, which can include merchant system 102, payment gateway 104, acquirer system 106, transaction service provider system 108, and/or issuer system 110, payee device 112, payer device 114, and/or communication network 116. Transaction processing network 101, merchant system 102, payment gateway 104, acquirer system 106, transaction service provider system 108, issuer system 110, payee device 112, and/or payer device 114 may interconnect (e.g., establish a connection to communicate) via wired connections, wireless connections, or a combination of wired and wireless connections.

Merchant system 102 may include one or more devices capable of receiving information from payment gateway 104, acquirer system 106, transaction service provider system 108, issuer system 110, payee device 112, and/or payer device 114 via communication network 116 and/or communicating information to payment gateway 104, acquirer system 106, transaction service provider system 108, issuer system 110, payee device 112, and/or payer device 114 via communication network 116. Merchant system 102 may include a device capable of receiving information from payer device 114 via a communication connection (e.g., an NFC communication connection, an RFID communication connection, a Bluetooth® communication connection, and/or the like) with payee device 112, and/or communicating information to payee device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway 104 may include one or more devices capable of receiving information from merchant system 102, acquirer system 106, transaction service provider system 108, issuer system 110, payee device 112, and/or payer device 114 via communication network 116 and/or communicating information to merchant system 102, acquirer system 106, transaction service provider system 108, issuer system 110, payee device 112, and/or payer device 114 via communication network 116. For example, payment gateway 104 may include a computing device, such as a server, a group of servers, and/or other like devices. In some non-limiting embodiments or aspects, payment gateway 104 is associated with a payment gateway as described herein.

Acquirer system 106 may include one or more devices capable of receiving information from merchant system 102, payment gateway 104, transaction service provider system 108, issuer system 110, payee device 112, and/or payer device 114 via communication network 116 and/or communicating information to merchant system 102, payment gateway 104, transaction service provider system 108, issuer system 110, payee device 112, and/or payer device 114 via communication network 116. For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information from merchant system 102, payment gateway 104, acquirer system 106, issuer system 110, payee device 112, and/or payer device 114 via communication network 116 and/or communicating information to merchant system 102, payment gateway 104, acquirer system 106, issuer system 110, payee device 112, and/or payer device 114 via communication network 116. For example, transaction service provider system 108 may include a computing device, such as a server (e.g., a transaction processing server), a group of servers, and/or other like devices. In some non-limiting embodiments or aspects, transaction service provider system 108 may be associated with a transaction service provider as described herein. In some non-limiting embodiments or aspects, transaction service provider system 108 may be a peer-to-peer payment transfer service provider.

Issuer system 110 may include one or more devices capable of receiving information from merchant system 102, payment gateway 104, acquirer system 106, transaction service provider system 108, payee device 112, and/or payer device 114 via communication network 116 and/or communicating information to merchant system 102, payment gateway 104, acquirer system 106, transaction service provider system 108, payee device 112, and/or payer device 114 via communication network 116. For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a payee associated with payee device 112, a payer associated with payer device 114, etc.).

In some non-limiting embodiments or aspects, transaction processing network 101 includes a plurality of systems in a communication path for processing a transaction. For example, transaction processing network 101 can include merchant system 102, payment gateway 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway 104, acquirer system 106, transaction service provider system 108, and/or issuer system 110.

Payee device 112 may include one or more devices capable of receiving information from merchant system 102, payment gateway 104, acquirer system 106, transaction service provider system 108, issuer system 110, and/or payer device 114 via communication network 116 and/or communicating information to merchant system 102, payment gateway 104, acquirer system 106, transaction service provider system 108, issuer system 110, and/or payer device 114 via communication network 116. For example, payee device 112 may include a client device and/or the like. In some non-limiting embodiments or aspects, payee device 112 may be capable of receiving information (e.g., from merchant system 102) via a short range wireless communication connection (e.g., an NFC communication connection, an RFID communication connection, a Bluetooth® communication connection, and/or the like), and/or communicating information (e.g., to merchant system 102) via a short range wireless communication connection. In some non-limiting embodiments or aspects, payee device 112 may include an application associated with payee device 112, such as an application stored on payee device 112, a mobile application (e.g., a mobile device application, a native application for a mobile device, a mobile cloud application for a mobile device, an electronic wallet application, a peer-to-peer payment transfer application, a real-time payment (RTP) application, and/or the like) stored and/or executed on payee device 112. In some non-limiting embodiments or aspects, a payee is a user associated with payee device 112 and/or a payee account in a peer-to-peer payment transfer service (e.g., an account identifier that uniquely identifies a payee account in the peer-to-peer payment transfer service, etc.).

Payer device 114 may include one or more devices capable of receiving information from merchant system 102, payment gateway 104, acquirer system 106, transaction service provider system 108, issuer system 110, and/or payee device 112 via communication network 116 and/or communicating information to merchant system 102, payment gateway 104, acquirer system 106, transaction service provider system 108, issuer system 110, and/or payee device 112 via communication network 116. For example, payer device 114 may include a client device and/or the like. In some non-limiting embodiments or aspects, payer device 114 may include an application associated with payer device 114, such as an application stored on payer device 114, a mobile application (e.g., a mobile device application, a native application for a mobile device, a mobile cloud application for a mobile device, an electronic wallet application, a peer-to-peer payment transfer application, and/or the like) stored and/or executed on payer device 114. In some non-limiting embodiments or aspects, a payer is a user associated with payer device 114 and/or a payer account in a peer-to-peer payment transfer service (e.g., an account identifier that uniquely identifies a payer account in the peer-to-peer payment transfer service, etc.).

Communication network 116 may include one or more wired and/or wireless networks. For example, communication network 116 may include a cellular network (e.g., a long-term evolution (LTE®) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

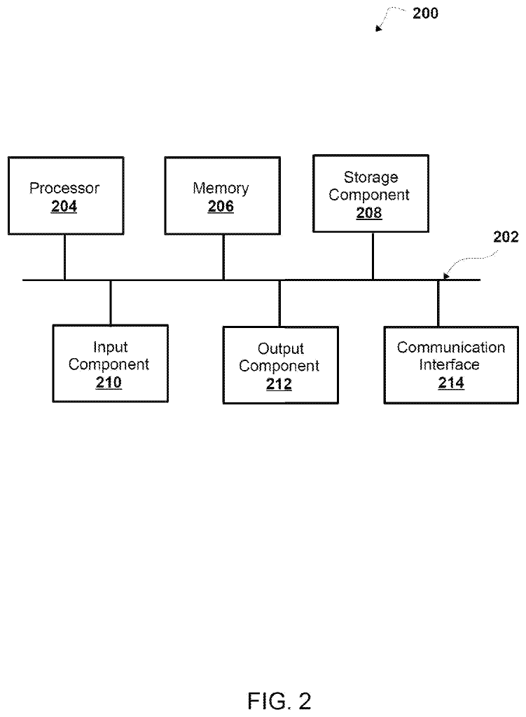

Referring now to FIG. 2, FIG. 2 is a diagram of example components of a device 200. Device 200 may correspond to one or more devices of merchant system 102, one or more devices of payment gateway 104, one or more devices of acquirer system 106, one or more devices of transaction service provider system 108, one or more devices of issuer system 110, and/or payee device 112 (e.g., one or more devices of a system of payee device 112, etc.). In some non-limiting embodiments or aspects, one or more devices of merchant system 102, one or more devices of payment gateway 104, one or more devices of acquirer system 106, one or more devices of transaction service provider system 108, one or more devices of issuer system 110, and/or payee device 112 (e.g., one or more devices of a system of payee device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 (e.g., a central processing unit (CPU), a graphics processing unit (GPU), etc.) executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

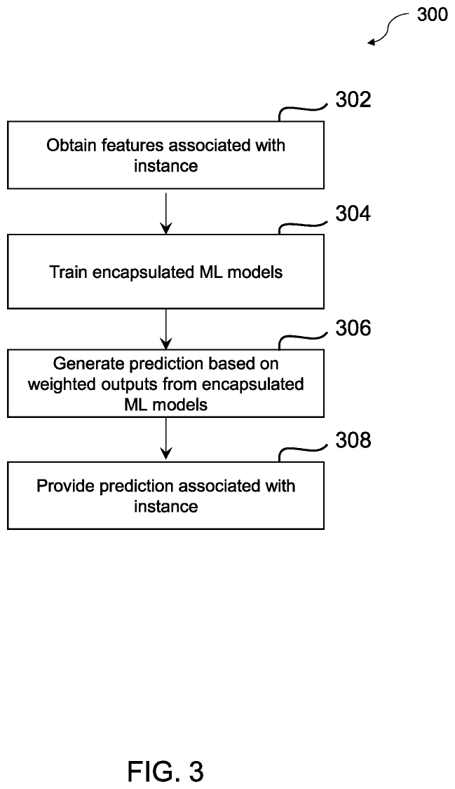

Referring now to FIG. 3, FIG. 3 is a flowchart of non-limiting embodiments or aspects of a process 300 for encapsulated multi-functional framework. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway 104 (e.g., one or more devices of payment gateway 104), acquirer system 106 (e.g., one or more devices of acquirer system 106), issuer system 110 (e.g., one or more devices of issuer system 110), and/or payee device 112.

As shown in FIG. 3, at step 302, process 300 includes obtaining a plurality of features associated with an instance. For example, transaction service provider system 108 may obtain a plurality of features associated with an instance. As an example, the plurality of features may include a first subset of the plurality of features associated with a first entity, a second subset of the plurality of features associated with a second entity, and a third subset of the plurality of features associated with each of the first entity and the second entity.

Transaction service provider system 108 may obtain the plurality of features associated with the instance by segmenting each feature of the plurality of features into one of the first subset, the second subset, and the third subset. For example, transaction service provider system 108 may obtain instance data associated with the instance. As an example, transaction service provider system 108 may process, using one or more feature generation techniques and/or one or more feature selection techniques, to obtain the plurality of features associated with the instance. In such an example, transaction service provider system 108 may segment each feature of the plurality of features into one of the first subset, the second subset, and the third subset according to one or more patterns in the instance data and/or features, data skew in the instance data and/or features, and/or one or more user preferences.

In some non-limiting embodiments or aspects, an instance includes a transaction in an RTP network, a first entity includes a payer and/or payer account associated with the payer, and/or a second entity includes a payee and/or payee account associated with a payee. For example, an instance may include a payment transaction initiated by a payer having an account at a first financial institution to send a payment to a payee having an account at a second financial institution different than the first financial institution in an RTP network. As an example, instance data may include transaction data. In such an example, transaction data may include at least one of the following parameters and/or features associated with a transaction: a transaction identifier, an amount, a payer or sender account, a payee or receiver account, a date, a time of day, a number of payments sent in a previous period of time by a payer or sender, a number of payments received in a previous period of time by a payee or receiver, an amount of payments sent in a previous period of time by a payer or sender, an amount of payments received in a previous period of time by a payee or receiver, and/or the like. For example, transaction service provider system 108 may segment, based on one or more patterns in the transaction data and/or features, data skew in the transaction data and/or features, and/or one or more user preferences, the parameters and/or features of the transaction data into one of the first subset (e.g., a payer or sender subset including parameters and/or features associated with the payer or sender, etc.), the second subset (e.g., a payee or receiver subset including parameters and/or features associated with the payee or receiver, etc.), and the third subset (e.g., a shared subset including parameters and/or features associated with each of the payer or sender and the payee or receiver, etc.).

In some non-limiting embodiments or aspects, an instance includes a credit application, a first entity includes a customer, and/or a second entity includes a merchant. For example, an instance may include an application for credit initiated by a customer to receive credit (e.g., a credit card associated with a brand of the merchant, a line of credit at the merchant, etc.) from a merchant. As an example, instance data may include credit data. In such an example, credit data may include at least one of the following parameters and/or features associated with a credit application: a credit application identifier, an amount of credit, an income associated with a customer, a credit score associated with a customer, a payment history associated with a customer, a debt-to-income ratio associated with a customer, an average amount spent by a customer at the merchant, a size of a merchant, a number of stores associated with a merchant in an area, a ratio of approved credit applications associated with approved customers similar to a customer, expenses of approved credit associated with approved customers similar to the customer, and/or the like. For example, transaction service provider system 108 may segment, based on one or more patterns in the credit data and/or features, data skew in the credit data and/or features, and/or one or more user preferences, the parameters and/or features of the credit data into one of the first subset (e.g., a customer or applicant subset including parameters and/or features associated with the customer or applicant for credit, etc.), the second subset (e.g., a merchant subset including parameters and/or features associated with the merchant, etc.), and the third subset (e.g., a shared subset including parameters and/or features associated with each of the customer or applicant and the merchant, etc.).

In some non-limiting embodiments or aspects, an instance includes a house price estimation, a first entity includes a house, and/or a second entity includes a neighborhood associated with the house. For example, an instance may include a request to estimate a price of a house initiated by a user. As an example, instance data may include housing data. In such an example, housing data may include at least one of the following parameters and/or features associated with a house price estimation: an address of a house, a square footage of a house, a number of rooms in a house, a number of floors in a house, a type of a house, a year built of a house, stores associated with a neighborhood, a safety rating associated with a neighborhood, an education level associated with a neighborhood, a population diversity of a neighborhood, a distance to a closest highway of a neighborhood, prices of other houses in a neighborhood having similar features, locations of other houses in a neighborhood, and/or the like. For example, transaction service provider system 108 may segment, based on one or more patterns in the housing data and/or features, data skew in the housing data and/or features, and/or one or more user preferences, the parameters and/or features of the housing data into one of the first subset (e.g., a house subset including parameters and/or features associated with the house, etc.), the second subset (e.g., a neighborhood subset including parameters and/or features associated with a neighborhood, etc.), and the third subset (e.g., a shared subset including parameters and/or features associated with each of the house and the neighborhood, etc.).

Non-limiting embodiments or aspects of the present disclosure are not limited to instances including payment transactions, credit applications, and/or housing price estimations, and instances and associated instance data may include other transactions and/or transaction data for other various applications.

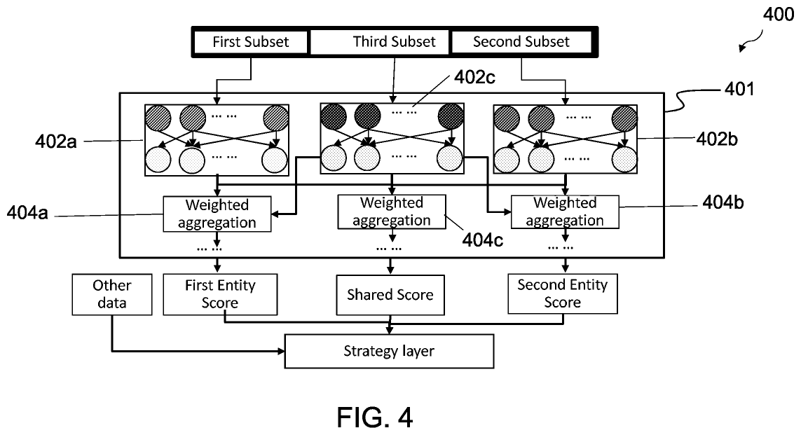

As shown in FIG. 3, at step 304, process 300 includes training a plurality of machine learning models encapsulated in a single framework. For example, and referring also to FIG. 4, which is a diagram of an implementation 400 of non-limiting embodiments or aspects of an encapsulated multi-functional framework, transaction service provider system 108 may train a plurality of machine learning models 402a, 402b, 402c encapsulated in a single framework 401. As an example, data and the methods that operate on that data for each of the plurality of machine models may be bundled and deployed together (e.g., in a single framework, file, object, etc.), and/or direct access to individual machine learning models of the plurality of machine learning models 402a, 402b, 402c and/or their components and/or the learnable weights may be restricted or prevented. In this way, non-limiting embodiments or aspects of the present disclosure may provide a framework that is friendlier and/or less costly for deployment and/or maintenance, model agnostic, and/or provides more precise predictions for more diverse user profiles.

Still referring to FIG. 4, transaction service provider system 108 may train the plurality of machine learning models 402a, 402b, 402c encapsulated in the single framework 401 by providing, as input to a first machine learning model 402a (e.g., to a first computational channel, etc.), the first subset of the plurality of features and, receiving as output from the first machine learning model 402a, a plurality of first outputs; providing, as input to a second machine learning model 402b (e.g., to a second computational channel, etc.), the second subset of the plurality of features and, receiving as output from the second machine learning model 402b, a plurality of second outputs; and/or providing, as input to a third machine learning model 402c (e.g., to a third computational channel, etc.), the third subset of the plurality of features and, receiving as output from the third machine learning model 402c, a plurality of third outputs. For example, the plurality of machine learning models may include supervised and/or unsupervised models, sequential and/or non-sequential models, and/or the like. As an example, the plurality of machine learning models 402a, 402b, 402c may include a plurality of neural networks, each neural network including an input layer including a plurality of input computation units, one or more hidden layers each including a plurality of hidden computation units, and/or an output layer including a plurality of output computation units. In such an example, each input computation unit of the input layer of each machine learning model may receive a single feature of the subset of features provided as input to that machine learning model, and/or each output computation unit of the output layer of each machine learning model may output a single output of the plurality of outputs (e.g., first, second, or third outputs) for that model. For example, each computation unit may treat input uniformly and contribute uniformly to output.

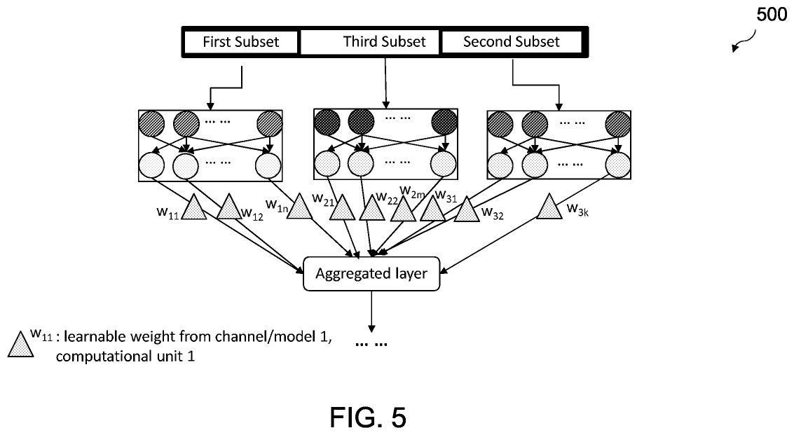

Still referring to FIG. 4, and referring also to FIG. 5, which is a diagram of an implementation 500 of non-limiting embodiments or aspects of learnable aggregation weights of an encapsulated multi-functional framework, transaction service provider system 108 may learn, based on the plurality of first outputs, the plurality of second outputs, and the plurality of third outputs, a plurality of first learnable weights 404a associated with the plurality of first outputs; learn, based on the plurality of first outputs, the plurality of second outputs, and the plurality of third outputs, a plurality of second learnable weights 404b associated with the plurality of second outputs; and/or learn, based on the plurality of first outputs, the plurality of second outputs, and the plurality of third outputs, a plurality of third learnable weights 404c associated with the plurality of third outputs. For example, the plurality of machine learning models 402a, 402b, 402c, the plurality of first learnable weights 404a, the plurality of second learnable weights 404b, and/or the plurality of third learnable weights 404c may be trained together within the single encapsulated framework using backpropagation and a loss function that depends on a prediction for the instance generated based on a plurality of first weighted outputs, a plurality of second weighted outputs, and a plurality of third weighted outputs as described herein in more detail with respect to implementation 400 shown in FIG. 4. As an example, the backpropagation may update the plurality of first learnable weights 404a, the plurality of second learnable weights 404b, and/or the plurality of third learnable weights 404c together according to the loss function.

The plurality of first learnable weights 404a may be applied to the plurality of first outputs from the first machine learning model to generate a plurality of first weighted outputs. For example, each learnable weight of the plurality of first learnable weights 404a may correspond to an output of the plurality of first outputs from the first machine learning model, and a dot product of that output with that corresponding learnable weight may be provided as a weighted output of the plurality of first weighted outputs. The plurality of second learnable weights 404b is applied to the plurality of second outputs from the second machine learning model to generate a plurality of second weighted outputs. For example, each learnable weight of the plurality of second learnable weights 404b may correspond to an output of the plurality of second outputs from the second machine learning model, and a dot product of that output with that corresponding learnable weight may be provided as a weighted output of the plurality of second weighted outputs. The plurality of third learnable weights 404c may be applied to the plurality of third outputs from the third machine learning model to generate a plurality of third weighted outputs. For example, each learnable weight of the plurality of third learnable weights 404c may correspond to an output of the plurality of third outputs from the third machine learning model, and a dot product of that output with that corresponding learnable weight may be provided as a weighted output of the plurality of third weighted outputs.

As shown in FIG. 3, at step 306, process 300 includes generating, based on a plurality of weighted outputs from a plurality of machine learning models encapsulated in a single framework, a prediction for an instance. For example, transaction service provider system 108 may generate, based on the plurality of first weighted outputs, the plurality of second weighted outputs, and the plurality of third weighted outputs, a prediction for the instance. As an example, transaction service provider system 108 may generate, based on the plurality of first weighted outputs, the plurality of second weighted outputs, and the plurality of third weighted outputs, a prediction for the instance by: generating a first entity score by aggregating the plurality of first weighted outputs; generating a second entity score by aggregating the plurality of second weighted outputs; generating a shared entity score by aggregating the plurality of third weighted outputs; and generating, based on the first entity score, the second entity score, and the shared entity score, the prediction for the instance. In such an example, the prediction may include a probability (e.g., a likelihood, a yes or no, an amount, etc.) associated with the instance. For example, a prediction for a payment transaction in an RTP network may include a probability that the payment transaction is a fraudulent and/or money-laundering transaction. As an example, a prediction for a credit application may include a probability associated with the credit application being approved and/or an amount for which the credit application is approved. For example, a prediction for a house price estimation may include a predicted sale price of a house.

In some non-limiting embodiments or aspects, transaction service provider system 108 may generate or modify a prediction for an instance based on other data, such as parameters, features, and/or the like, that is not provided as input to the plurality of machine learning models 402a, 402b, 402c. For example, other data may include expert knowledge and/or client requirements. As an example, in a payment transaction scenario, other data may include one or more locations of one or more data centers used to process the payment transaction and/or one or more parameters specified by a financial institution associated with a payer account and/or a payee account for the payment transaction. For example, a prediction for a payment transaction in an RTP network may be calculated according to one of the following formulas: (i) prediction score=sender score∧2*a1+sender FI flag ∧−1.5*a2+sender amount velocity*a3, where a1, a2, a3 are customizable parameters; (ii) prediction score=txn score*b₁+txn amount velocity*b₂+receiver score*b₃+receiver count velocity*b₄, where b1, b2, b3 are customizable parameters; or (iii) prediction score=receiver score ∧3*c1+receiver whitelist score*c2+txn amount velocity*c3, where c1, c2, c3 are customizable parameters.

In this way, non-limiting embodiments or aspects of the present disclosure may provide a highly customizable and flexible system that provides rich output in real-time to meet diverse client (e.g., financial institution, etc.) requirements.

As shown in FIG. 3, at step 308, process 300 includes providing a prediction associated with the instance. For example, transaction service provider system 108 may provide the prediction for the instance.

Transaction service provider system 108 may provide the prediction for the instance with the plurality of first learnable weights, the plurality of second learnable weights, and/or the plurality of third learnable weights. For example, transaction service provider system 108 may extract values of the plurality of first learnable weights, the plurality of second learnable weights, and/or the plurality of third learnable weights from the single encapsulated framework and output the plurality of first learnable weights, the plurality of second learnable weights, and/or the plurality of third learnable weights with the prediction for the instance. As an example, a contribution or importance of different computation channels may be determined based on values of learnable weights for different computational channels. In such an example, a larger contribution or importance may be assigned to a computational channel having a larger absolute value of a learnable weight for the computational channel. In this way, a user may understand which computational channel has the largest impact on the model decision making, thereby providing a more explainable framework that gives the user more confidence to use the predictions therefrom.

In some non-limiting embodiments or aspects, an instance includes a transaction between a payer account and a payee account in an RTP network, a first entity includes the payer account, a second entity includes the payee account, and/or a prediction includes a probability that the transaction is a fraudulent and/or money laundering transaction. Transaction service provider system 108 (and/or issuer system 110, etc.) may automatically authorize or automatically deny the transaction in the RTP network based on the prediction. For example, transaction service provider system 108 may automatically deny the payment transaction if the prediction indicates that the transaction is a fraudulent transaction and/or a money laundering transaction (e.g., if the probability satisfies a threshold probability, etc.). As an example, transaction service provider system 108 may automatically authorize the transaction if the prediction indicates that the transaction is not a fraudulent transaction and/or a money laundering transaction (e.g., if the probability fails to satisfy a threshold probability, etc.). As an example, transaction service provider system 108 may automatically perform an account validation of the account if the prediction indicates that the transaction is associated with a suspicious/high-risk account (e.g., if the probability satisfies a threshold probability, etc.). As an example, transaction service provider system 108 may not perform an account validation of the account if the prediction indicates that the transaction is not associated with a suspicious/high-risk account (e.g., if the probability fails to satisfy a threshold probability, etc.). An account validation or instant bank verification may include a process of automatically verifying (e.g., with a financial institution or issuer system 110 that issued an account, etc.) that the account number and account details of an account are valid before the current transaction is processed.

A fraud and/or money laundering deterrence action may be performed by transaction service provider system 108 to automatically suspend, in response to detecting the fraudulent and/or money laundering activity, at least one of a transaction activity of the account and access of the account to a system (e.g., to block access of the account to the RTP network, etc.). The fraud deterrence action may be performed by transaction service provider system 108 to automatically transmit information associated with the account to a database (e.g., a transaction service provider database, an issuer database, etc.) to flag the account as associated with fraudulent activity and/or to suspend a transaction activity and/or access of the account to transaction service provider system 108, issuer system 110, the RTP network, and/or a subsystem thereof. The fraud deterrence action may be performed by transaction service provider system 108 by automatically transmitting the account(s) to issuer system(s) 110 associated with the account(s) to notify the issuers that the account(s) is now associated with fraudulent activity and/or to cancel the transaction attempted by the account(s). The fraud deterrence action may be performed by transaction service provider system 108 and/or issuer system 110 by automatically transmitting a communication to payee device 112 of a user associated with the account(s).

In some non-limiting embodiments or aspects, an instance includes a credit application initiated by a customer with a merchant, a first entity includes the customer, a second entity includes the merchant, and/or a prediction includes an amount for which the credit application is approved. Transaction service provider system 108 (and/or merchant system 102, etc.) may automatically approve, based on the prediction, the credit application for the amount.

In some non-limiting embodiments or aspects, an instance includes a house price estimation for a house in a neighborhood, a first entity includes the house, a second entity includes the neighborhood, and/or a prediction includes an estimated price of the house. Transaction service provider system 108 (and/or merchant system 102, etc.) may automatically control, based on the prediction, a display to display the estimated price of the house in a map of the neighborhood at a location of the house in the map. For example, transaction service provider system 108 (and/or merchant system 102, etc.) may automatically control a size of an icon associated with the house in the displayed map based on the estimated price of the house (e.g., make the icon bigger, make the icon smaller, add the icon to the map, remove or filter the icon from the map, etc.).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A method, comprising:
obtaining, with at least one processor, a plurality of features associated with an instance, wherein the plurality of features includes a first subset of the plurality of features associated with a first entity, a second subset of the plurality of features associated with a second entity, and a third subset of the plurality of features associated with each of the first entity and the second entity;
training, with the at least one processor, a plurality of machine learning models encapsulated in a single framework, by:
providing, as input to a first machine learning model, the first subset of the plurality of features and, receiving as output from the first machine learning model, a plurality of first outputs;
providing, as input to a second machine learning model, the second subset of the plurality of features and, receiving as output from the second machine learning model, a plurality of second outputs;
providing, as input to a third machine learning model, the third subset of the plurality of features and, receiving as output from the third machine learning model, a plurality of third outputs;
learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs;
learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and
learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs;
generating, with the at least one processor, based on the plurality of first weighted outputs, the plurality of second weighted outputs, and the plurality of third weighted outputs, a prediction for the instance; and
providing, with the at least one processor, the prediction for the instance.

2. The method of claim 1, wherein the obtaining, with the at least one processor, the plurality of features associated with the instance includes:
segmenting each feature of the plurality of features into one of the first subset, the second subset, and the third subset.

3. The method of claim 1, wherein the generating, with the at least one processor, based on the plurality of first weighted outputs, the plurality of second weighted outputs, and the plurality of third weighted outputs, the prediction for the instance includes:
generating a first entity score by aggregating the plurality of first weighted outputs;
generating a second entity score by aggregating the plurality of second weighted outputs;
generating a shared entity score by aggregating the third plurality of third weighted outputs; and
generating, based on the first entity score, the second entity score, and the shared entity score, the prediction.

4. The method of claim 1, wherein the prediction for the instance is provided with the plurality of first learnable weights, the plurality of second learnable weights, and the plurality of third learnable weights.

5. The method of claim 1, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the method further includes:
automatically authorizing or automatically denying, with the at least one processor, based on the prediction, the transaction.

6. The method of claim 1, wherein the instance includes a credit application initiated by a customer with a merchant, wherein the first entity includes the customer, wherein the second entity includes the merchant, wherein the prediction includes an amount for which the credit application is approved, and wherein the method further includes:
automatically approving, with the at least one processor, based on the prediction, the credit application for the amount.

7. The method of claim 1, wherein the instance includes a house price estimation for a house in a neighborhood, wherein the first entity includes the house, wherein the second entity includes the neighborhood, wherein the prediction includes an estimated price of the house, and wherein the method further includes:
automatically controlling, with the at least one processor, based on the prediction, a display to display the estimated price of the house in a map of the neighborhood at a location of the house in the map.

8. A system, comprising:
at least one processor programmed and/or configured to:
obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity;
train a plurality of machine learning models encapsulated in a single framework, by:
providing, as input to a first machine learning model, the first subset of the plurality of features and, receiving as output from the first machine learning model, a plurality of first outputs;
providing, as input to a second machine learning model, the second subset of the plurality of features and, receiving as output from the second machine learning model, a plurality of second outputs;
providing, as input to a third machine learning model, the third subset of the plurality of features and, receiving as output from the third machine learning model, a plurality of third outputs;
learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs;
learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and
learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs;
generate, based on the plurality of first weighted outputs, the plurality of second weighted outputs, and the plurality of third weighted outputs, a prediction for the instance; and
provide the prediction for the instance.

9. The system of claim 8, wherein the at least one processor is programmed and/or configured to obtain the plurality of features associated with the instance by:
segmenting each feature of the plurality of features into one of the first subset, the second subset, and the third subset.

10. The system of claim 8, wherein the at least one processor is programmed and/or configured to generate, based on the plurality of first weighted outputs, the plurality of second weighted outputs, and the plurality of third weighted outputs, the prediction for the instance by:
generating a first entity score by aggregating the plurality of first weighted outputs;
generating a second entity score by aggregating the plurality of second weighted outputs;
generating a shared entity score by aggregating the plurality of third weighted outputs; and
generating, based on the first entity score, the second entity score, and the shared entity score, the prediction.

11. The system of claim 8, wherein the prediction for the instance is provided with the plurality of first learnable weights, the plurality of second learnable weights, and the plurality of third learnable weights.

12. The system of claim 8, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the at least one processor is further programmed and/or configured to:
automatically authorize or automatically deny, based on the prediction, the transaction.

13. The system of claim 8, wherein the instance includes a credit application initiated by a customer with a merchant, wherein the first entity includes the customer, wherein the second entity includes the merchant, wherein the prediction includes an amount for which the credit application is approved, and wherein the at least one processor is further programmed and/or configured to:
automatically approve, based on the prediction, the credit application for the amount.

14. The system of claim 8, wherein the instance includes a house price estimation for a house in a neighborhood, wherein the first entity includes the house, wherein the second entity includes the neighborhood, wherein the prediction includes an estimated price of the house, and wherein the at least one processor is further programmed and/or configured to:
automatically control, based on the prediction, a display to display the estimated price of the house in a map of the neighborhood at a location of the house in the map.

15. A computer program product comprising at least one non-transitory computer-readable medium including program instructions that, when executed by at least one processor, cause the at least one processor to:
obtain a plurality of features associated with an instance, wherein the plurality of features includes a first subset of the plurality of features associated with a first entity, a second subset of the plurality of features associated with a second entity, and a third subset of the plurality of features associated with each of the first entity and the second entity;
train a plurality of machine learning models encapsulated in a single framework, by:
providing, as input to a first machine learning model, the first subset of the plurality of features and, receiving as output from the first machine learning model, a plurality of first outputs;
providing, as input to a second machine learning model, the second subset of the plurality of features and, receiving as output from the second machine learning model, a plurality of second outputs;
providing, as input to a third machine learning model, the third subset of the plurality of features and, receiving as output from the third machine learning model, a plurality of third outputs;
learning, based on the plurality of first outputs, the plurality of second outputs, and the plurality of third outputs, a plurality of first learnable weights associated with the plurality of first outputs, wherein the plurality of first learnable weights is applied to the plurality of first outputs to generate a plurality of first weighted outputs;
learning, based on the plurality of first outputs, the plurality of second outputs, and the plurality of third outputs, a plurality of second learnable weights associated with the plurality of second outputs, wherein the plurality of second learnable weights is applied to the plurality of second outputs to generate a plurality of second weighted outputs; and
learning, based on the plurality of first outputs, the plurality of second outputs, and the plurality of third outputs, a plurality of third learnable weights associated with the plurality of third outputs, wherein the plurality of third learnable weights is applied to the plurality of third outputs to generate a plurality of third weighted outputs;
generate, based on the plurality of first weighted outputs, the plurality of second weighted outputs, and the plurality of third weighted outputs, a prediction for the instance; and
provide the prediction for the instance.

16. The computer program product of claim 15, wherein the program instructions, when executed by the at least one processor, cause the at least one processor to obtain the plurality of features associated with the instance by:
segmenting each feature of the plurality of features into one of the first subset, the second subset, and the third subset.

17. The computer program product of claim 15, wherein the program instructions, when executed by the at least one processor, cause the at least one processor to generate, based on the plurality of first weighted outputs, the plurality of second weighted outputs, and the plurality of third weighted outputs, the prediction for the instance by:
generating a first entity score by aggregating the plurality of first weighted outputs;
generating a second entity score by aggregating the plurality of second weighted outputs;
generating a shared entity score by aggregating the plurality of third weighted outputs; and
generating, based on the first entity score, the second entity score, and the shared entity score, the prediction, wherein the prediction for the instance is provided with the plurality of first learnable weights, the plurality of second learnable weights, and the plurality of third learnable weights.

18. The computer program product of claim 15, wherein the instance includes a transaction between a payer account and a payee account in a real-time payment (RTP) network, wherein the first entity includes the payer account, wherein the second entity includes the payee account, wherein the prediction includes a probability that the transaction is a fraudulent and/or money laundering transaction, and wherein the program instructions, when executed by the at least one processor, further cause the at least one processor to:
automatically authorize or automatically deny, based on the prediction, the transaction.

19. The computer program product of claim 15, wherein the instance includes a credit application initiated by a customer with a merchant, wherein the first entity includes the customer, wherein the second entity includes the merchant, wherein the prediction includes an amount for which the credit application is approved, and wherein the program instructions, when executed by the at least one processor, further cause the at least one processor to:
automatically approve, based on the prediction, the credit application for the amount.

20. The computer program product of claim 15, wherein the instance includes a house price estimation for a house in a neighborhood, wherein the first entity includes the house, wherein the second entity includes the neighborhood, wherein the prediction includes an estimated price of the house, and wherein the program instructions, when executed by the at least one processor, further cause the at least one processor to:
automatically control, based on the prediction, a display to display the estimated price of the house in a map of the neighborhood at a location of the house in the map.
